(19) United States
(12) Patent Application Publication
(10) Pub. No.: US 2015/0164090 A1
(43) Pub. Date: Jun. 18, 2015

(54) CRISP BAKED PRODUCTS COMPRISING XYLANASE

(71) Applicant: DSM IP ASSET B.V., Heerlen (NL)

(72) Inventors: Neil Carr, Echt (NL); Margot Elisabeth Francoise Schooneveld-Bergmans, Echt (NL); Jose Mastenbroek, Echt (NL)

(21) Appl. No.: 14/407,575

(22) PCT Filed: Jul. 3, 2013
(86) PCT No.: PCT/EP2013/064029

§ 371 Date: Dec. 12, 2014

Related U.S. Application Data
(60) Provisional application No. 61/668,209, filed on Jul. 5, 2012.

(30) Foreign Application Priority Data
Jul. 5, 2012 (EP) 12175152.3

(51) Int. Cl. A21D 2/26; A21D 13/00

(52) U.S. Cl. CPC A21D 2/267; A21D 13/008; A21D 13/0035

(57) ABSTRACT

The present invention relates to crisp baked products with improved storage stability and to a method for preparing these. The method comprises preparing the crisp baked product from a dough or batter to which xylanase has been added.

### FIELD OF THE INVENTION

The present invention relates to the production of baked products. In particular to the production of crisp baked products.

### BACKGROUND OF THE INVENTION

Crisp baked products are widely produced and consumed throughout the world. They are produced as dry products and have a long shelf life as long as they are in their packaging. However, once they are unpacked, most crisp backed products quickly lose their appetizing qualities since they easily take up moisture from the environment.

Biscuits, for example, are of low moisture when produced (<5% w/w) and typically have a water activity (a_{w}) between 0.2-0.3, while most temperate climates bring an atmosphere with water activity higher than 0.4. Since differences in water activity lead to a re-equilibration of moisture, there will be a migration of moisture from the atmosphere to the biscuit once packaging has been removed. The biscuits then become moister, which in turn leads to a loss of hardness and development of flavour defects.

It is also very common for biscuits to be sold as a composite product, comprising various inclusions, fillings and coatings besides the crisp product and in such cases a re-equilibration of water occurs until the water activity is equal across the composite parts. For example, in sandwich biscuits with soft and fudgey fillings of contrasting texture to the hard basic biscuit, there will be an equilibration of moisture across the filling and the biscuit until gradients in a_{w} are fully lost. This places constraint on the biscuit formulator on the amount of moisture that can be used within the filling, or composite part, and the extent to which these can be softened by use of moisture.

Solutions so far has been to make fillings which have low water activity. For example, patent application U.S. Pat. No. 6,660,314 describes a low water activity filling for biscuit products based on a mixture of sugars. Patent application EP 372 596 describes a low water activity filling for biscuit products based on fibers. These fillings are often tough, not tasty or require labelling of the biscuit product.

Therefore, there remains a need for a crisp baked product which keeps its crispiness in moist environment and during storage.

### BRIEF DESCRIPTION OF THE DRAWINGS

FIG. 1 schematically depicts an embodiment of a crisped baked product according to the invention showing a schematic cross-section of a composite biscuit product comprising a filling 2 sandwiched between two biscuits 1a and 1b.

FIG. 2 schematically depicts an embodiment of a crisped baked product according to the invention showing a schematic cross-section of a composite biscuit product comprising a biscuit 101 fully enrobed by a coating 102.

FIG. 3 schematically depicts an embodiment of a crisped baked product according to the invention showing a schematic cross-section of a composite biscuit product comprising a biscuit 201 with a coating 202.

FIG. 4 schematically depicts an embodiment of a crisped baked product according to the invention showing a schematic cross-section of a composite biscuit product comprising a biscuit 301 with an inclusion 302.

### DETAILED DESCRIPTION OF THE INVENTION

The present invention relates to a method for preparing a crisp baked product. The method comprises:
preparing a wheat flour dough or batter with added xylanase;
baking the dough to make a crisp baked product which on production or after storage has a water activity (a_{w}) of at least 0.35 while having at least 80% of the hardness of a reference crisp baked product with a water activity (a_{w}) of about 0.25 which is prepared with no added xylanase.

Crisp baked products, such as biscuits, typically lose hardness as a_{w} rises above 0.35 (w/w) and moisture levels above 5% w/w. (Manley, D. (2000) Technology of Biscuits, Crackers and Cookies. Third Edition. Woodhead Publishing, Cambridge, UK; Manley, D. (2001) Biscuit, Cracker and Cookie Recipes for Food Industry. Woodhead Publishing, Cambridge, UK). The method according to the invention brings advantage to the producer as the crisp baked product will be less prone to lose hardness at increased water activity or at higher moisture levels (moisture levels of 5% w/w or more). The method also permits wider formulation scope within for example composite-biscuits; specifically the use of inclusions, fillings and coatings of higher moisture, and more appealing texture, can be more readily accepted within stable composite formulations. Thus using the method of the invention, crisp baked products of improved storage stability and improved hardness can be made.

In an aspect the method of the invention may provide crisp baked products having a moisture level of at least 5%, in an aspect at least 6%, in an aspect at least 7%, in an aspect at least 8% which retain their crispiness better over time as compared to a reference product without the xylanase.

In an aspect the method of the invention may provide crisp baked products that under conditions of the same water activity and the same moisture content have an increased hardness as compared to a reference product prepared without the xylanase.

In the context of the present invention, the term ‘dough’ refers to an elastic, pliable protein network mixture that minimally comprises a flour or meal and a liquid, such as milk or water, which is typically used to prepare a food product.

In the context of the present invention, the term ‘batter’ refers to a dough with high levels of water, typically 125-150 wt % based on flour weight, which can be used to make various foods, including wafers.

The wheat flour dough or batter which is used in the method according to the invention may also comprise other cereals, such as rye, oats, rice, maize and barley, and ingredients such as leavening salts, salt, flavour, syrups, yeast, malt, milk powders, whole grains, chocolate chunks, confectionery pieces as well as functional additives such as sodium metabisulfite, emulsifiers, ascorbic acid and enzymes. In a preferred embodiment, the wheat flour dough or batter comprises wheat as the only cereal. The baking of the dough to make a crisp baked product is preferably performed using an oven or a wafer press.

The xylanase which is added to the dough or batter may be any xylanase. In the context of the present invention, “xylanase” refers to glycosidases (O-glycoside hydrolysases EC 3.2.1.x) which catalyse the endohydrolysis of 1,4-beta-D-xylosidic linkages in xylan. In one embodiment, the xylanase is a family 10 or family 11 xylanase. In another embodiment, the xylanase is an endo-1,4-beta-xylanase (EC 3.2.1.8). The xylanase to be used in the method according to the invention may be obtainable from any organism, be it a plant, animal or microorganism, such as a bacterium, fungus, yeast or virus. Well-known xylanase producers include bacteria and fungi, such as Bacillus, in particular B. subtilis, B. amyloliquefaciens, B. licheniformis, B. puntis, B. megaterium, B. halodurans or B. pumilus; Aspergillus, in particular Aspergillus awamori, Aspergillus foetidus, Aspergillus sojae, Aspergillus fumigatus, Aspergillus oryzae and A. niger; Humicola, in particular H. insolens, H. lanuginosa, Talaromyces, in particular T. emersoni and Trichoderma in particular T. viride and T. reesei. For an overview of xylanase classification and producers, see Collins et al, FEMS Microbiol. Rev. (2005) 29:3-23. The xylanase may have been produced in any convenient way, be it naturally or by modern techniques such as genetic engineering, which includes cloning, mutation and nucleotide or protein synthesis. In a preferred embodiment of the invention, the xylanase is of fungal origin, preferably from a filamentous fungus, more preferably from Trichoderma viride or Talaromyces emersonii. In an aspect the xylanase is the Talaromyces emersonii xylanase polypeptide comprising an amino acid sequence as set out in amino acids 23-408 of SEQ ID NO:2, or a variant of at least 90% identity, as described in WO2002/24926.

The xylanase may be comprised in a xylanase preparation comprising or consisting of xylanase. The xylanase preparations comprising xylanase may comprise between 0.001% and 100% w/w xylanase based on total protein. Preferably, the preparations comprises between 1% and 70% w/w xylanase based on total protein. In one embodiment, the preparation comprises between 1% and 50% w/w xylanase based on total protein. In yet another embodiment, the preparation comprises between 1% and 30% w/w xylanase based on total protein. The xylanase may be the major enzymatic component in the xylanase preparation, for example, in a monocomponent preparation. Alternatively, the xylanase preparation may comprise several enzymatic activities, as long as they do not interfere with the benefits offered by the xylanase.

In another preferred embodiment of the invention, xylanase or xylanase preparations are used that lead to a substantial increase in dough fluidity. This property can be demonstrated by the Farinograph® protocol (Brabender Tenchnologie KG, Germany); this method is widely used in the cereals industry to determine the water absorption (WA) as well as measuring the mixing characteristics of flours. In this method a simple dough is made using flour and sufficient water to achieve a dough consistency to the 600 Brabender Units (BU) line. Preferably, flour specified for use in the production of biscuits is used. This is typically flour from soft milling wheats being of relativley low protein (7-10% w/w). A commercial flour suitable for this assessment would be Golden Dawn, of 9.7% w/w protein, supplied by ADM Milling, UK. The Farinograph® machine provides a continual measure of the torque of mixing; after reaching a peak in the torque value the procedure is continued for several minutes with any loss of torque during this time indicating that the dough has become more fluid. In a preferred embodiment of this invention, a measure termed “degree-of-softening” is recorded which is the decrease in Brabender Units (BU) over 12 minutes after the peak value of torque has been reached. In yet another preferred embodiment, the xylanase is of a nature and amount to give a degree-of-softening of at least 50 BU above the degree-of-softening achieved in dough with no added xylanase.

In another preferred embodiment, the method comprises using dough which comprises 880-8000 xylanase units/kg of flour. Preferably, the biscuit dough comprises 1000-6000 xylanase units/kg of flour. More preferably, the dough comprises 1500-5000 xylanase units/kg of flour. Xylanase units (also denoted as XTU) are determined by an assay that determines an increase in reducing sugar after incubating the enzyme with rye xylan at 40° C. and pH 4.5. One xylanase unit is defined as the amount of enzyme needed to produce reducing sugar at a rate of 1 μmol/min in terms of glucose equivalence. At atmospheric pressure and at 40 degrees C. Reducing sugar is measured using established laboratory procedures, for example following the principle outlined by Somogyi (Somogyi, M. J. Biol. Chem. 195: 19-23 (1952)) after incubating enzyme with excess amounts of solubilised xylan. Preferably, the period of incubation is for exactly 10 minutes using xylan at a concentration of 5 mg/ml and xylanase of activity within the range of 0.04 to 0.06 xylanase units/ml in the incubation mixture.

The xylanase is mixed with the other ingredients of the dough or batter while preparing the dough or batter.

Using the method of the invention, crisp baked products can be prepared with improved storage stability, i.e. which are less prone to lose hardness when stored, and in particular when stored and exposed to moisture, compared to crisp baked products prepared with no added xylanase.

Therefore, in another aspect, the present invention relates to a crisped baked product produced according to the method of the invention.

In the context of the present invention, the term “crisp baked product” refers to a crisp or crunchy baked product prepared from a wheat flour dough or batter by baking, usually in an oven. Known crisp baked products typically have a moisture content lower than 5% w/w, and an a_{w} of about 0.2-0.3, which will further be referred to as about a_{w} 0.25. These are typically bakery products and include biscuits and certain styles of bread. In a preferred embodiment, the crisp baked product is a biscuit product.

In the context of the present invention, the term “biscuit” or “biscuit product” refers to a bakery product predominantly based on wheat flour, commonly water, sugar and fat, and baked to form snack products of hard, crisp or crunchy texture. Known biscuits typically contain less than 5% w/w. It encompasses products made from “hard-doughs”, “short-doughs”, and some forms of batter and includes crackers, semi-sweet biscuits, crispbreads, digestives, cookies, shortbreads, and wafers. This definition then excludes hard snack products that are not produced by baking, for example by extrusion or frying, as well as certain styles of “cookie” that are produced to be soft and chewy and not to be crisp or crunchy.

Hard-dough biscuit products are formed from dough containing relatively little fat, in particular 5-22 wt % based on flour weight, and low to moderate levels of sugar, in particular, 0-35 wt % based on flour weight, with the dough being made principally from flour and water. Typically, the dough comprises 20-50% water based on flour weight. A fermentation stage may be present. The moisture content of the known final biscuit after baking is typically less than 5% (w/w). Examples of hard-dough biscuits include crackers, crispbreads, and semi-sweet biscuits such as marie biscuits.

Short-dough biscuit products contrast with hard-dough products, in that less water is present in the recipe (0-20 wt % based on flour weight), while fat content is relatively high (20-60% on flour weight) such that the dough becomes “short”, forming a crumbly mix. Typically, higher sugar levels are used (20-75 wt % based on flour weight). Known short dough biscuits, are typically baked to products of low moisture (<5% w/w). Examples of short-dough biscuit include digestives, cookies, shortbread, and gingernuts. In one preferred embodiment of the invention, the biscuit product produced is a short-dough biscuit product.

Wafers are made from batter and, as such, use higher levels of water in the mix (125-150 wt % based on flour weight) relative to short-dough and hard-dough types. Only moderate levels of sugar and fat are included in the recipe (in the range of 1-4% for both based on flour weight). Known wafer-biscuits are typically baked in wafer-presses to form a product of low moisture (<5% w/w).

Apart from the main ingredients wheat flour, water, sugar and fat, biscuits may also include leavening salts, salt, flavour, syrups, yeast, malt, milk powders, whole grains, chocolate chunks, confectionery pieces as well as functional additives such as sodium metabisulfite, emulsifiers, ascorbic acid and enzymes. The basic biscuit is often complimented by use of dustings, typically salt or sugar dustings; inclusions, such as chocolate chunks, mallow pieces, candy pieces, whole grains or jelly sweets; fillings, such as cream fillings, jam fillings or mallows, as can be find in for example bourbons, jaffa cakes, jammy dodgers and wagon wheels; or coatings, such as chocolate coating, couverture or icing, whereby the biscuit may be partly covered or fully enrobed; and often assembled and sold as a composite product. In the context of the present invention, the term “composite-biscuit” is used to mean biscuit together with these complimentary parts.

The water activity (a_{w}) of a substance is defined as the ratio of vapour pressure of the water in the substance over that of pure water. That is a_{w}=p/pₒ, where p=partial water pressure of the test substance and pₒ=partial water pressure of pure water at the same temperature and pressure. ERH (equilibrium relative humidity) provides the same measurement on percent scale rather than a fractional scale; that is ERH (%)=a_{w}×100. In the context of present invention, water activity is measured at atmospheric pressure and at 20 degrees C.

While there are general relationships between the a_{w} of a substance and its moisture content, a_{w} is a function of a number of physical and chemical characteristics of the substance besides moisture content alone. Most importantly the re-equilibration of moisture is governed by differences in a_{w} rather than by absolute differences in moisture, such that moisture will move from one substance to another, or between a substance and the surrounding atmosphere, until the a_{w} across all parts have equalized. Practically a_{w} can be measured using well established laboratory procedures based on capacitance or dew point hygrometers.

Moisture content may be measured by any suitable method available in the art. In one embodiment it is measured by comparing mass before and after drying, typically in an oven, until constant weight. The skilled person will understand that the most suitable method for determining moisture will depend on the material or composition of which the water content is to be measured.

Crisp baked products according to the invention have improved storage stability compared to reference crisp baked products. In the context of the present invention, the reference crisp or crunchy baked product is always made without xylanase being added to the dough or batter used to prepare the crisp baked product.

Crisp baked products according to the invention have an a_{w} of at least 0.35, while having substantially the same hardness as reference crisp baked product prepared without adding xylanase to the dough or batter with an a_{w} of about 0.25. Preferably, crisp baked products according to the invention have an a_{w} in the range 0.4-0.5 while having substantially the same hardness as a reference crisp baked product with an a_{w} of about 0.25. More preferably, crisp baked products according to the invention have an a_{w} in the range 0.6-0.7 while having substantially the same hardness as a reference crisp baked product with an a_{w} of about 0.25. In the context of the present invention, “substantially the same hardness” indicates a hardness which is at least 80%, preferably at least 85%, more preferably at least 90% of the hardness of a reference crisp baked product with no added xylanase having an a_{w} of about 0.25. In one embodiment, a crisp baked product with an a_{w} of about 0.45 has at least 80% of the hardness of a reference crisp baked product with an a_{w} of about 0.25.

At the same time, the moisture level of the baked product according to the invention may be increased, for example because of the uptake of moisture from the atmosphere. The moisture content of the crisp baked product according to the invention may be 5% w/w or more, 6% w/w or more or even 7% w/w or 8% w/w or more. Even under these conditions of increased moisture, the crisp baked products according to the invention will have substantially the same hardness as a reference crisp baked product prepared without added xylanase with a_{w} of about 0.25. In one embodiment, a crisp baked product with a moisture level of about 6% w/w has at least 80% of the hardness of a reference crisp baked product with a moisture level of about 4% w/w. In another embodiment, a crisp baked product with an a_{w} of about 0.45 and moisture level of about 6% w/w has at least 80% of the hardness of a reference crisp baked product with an a_{w} of about 0.25 and a moisture level of about 4% w/w.

Surprisingly, a crisp baked product according to the invention with increased moisture level will have improved hardness in comparison to a reference crisp baked product (i.e. one prepared from dough or batter to which no xylanase has been added) with increased moisture level. In one embodiment, a crisp baked product according to the invention with a moisture level of 5% w/w or more has improved hardness compared to a reference crisp baked product with a moisture level of 5% w/w or more. In another embodiment, a crisp baked product with an a_{w} of about 0.45 and a moisture level of 5% w/w or more has improved hardness compared to a reference crisp baked product with an a_{w} of about 0.45 and a moisture level of 5% w/w or more. In yet another embodiment a crisp baked product with an a_{w} of about 0.45 and a moisture level of 5% w/w or more has improved hardness compared to a reference crisp baked product with an a_{w} of about 0.45 and having the same moisture level as the crisp baked product. Therefore, the method according to the invention allows crisp baked products to be made of higher moisture and higher water activity while retaining improved hardness.

In the context of the present invention, the hardness of the crisp baked product may be measured by any available method. In one embodiment, the hardness of a biscuit is measured by a three point bend texture analysis. In this test, a biscuit is suspended between two mounts 2 cm apart, while a rounded probe of 6 mm width is pressed downwards on the biscuit midway between the two mounts until the biscuit fractures. Preferably, the biscuit is approximately 0.6-1.0 cm thick. The maximum force recorded before the biscuit breaks gives a measure of the hardness of the biscuit. This test uses a texture analyzer, preferably TAXT2 (Stable Micro Systems UK) with a probe compression speed of 3 mm/s. The hardness of the biscuit is preferably measured when moisture has fully equilibrated across the biscuit. The hardness may be improved if the hardness value of the crisp baked product is higher as compared to a reference product prepared without the xylanase, while both products have the same water activity.

In an aspect, the hardness is improved if a crisp baked product having a water activity (a_{w}) of at least 0.35, has at least 80% of the hardness of a reference crisp baked product prepared with no added xylanase having a water activity (a_{w}) of about 0.25.

Once equilibrated with its environment, a crisp baked product according to the invention having an a_{w} of at least 0.35 retains its hardness for at least 48 hours, more preferably for at least 3, 4, 5, or 6 days, even more preferably, for at least one week, two weeks, three weeks or four weeks, most preferably, for at least 1 month, 2 months, 3 months or 4 months, wherein “retains” indicates that the reduction in hardness is less than 5%, 4%, 3%, preferably less than 2% or 1%. In an aspect, the storage stability is improved if a crisp baked product according to the invention having an a_{w} of at least 0.35 retains its hardness for at least 48 hours, more preferably for at least 3, 4, 5, or 6 days, even more preferably, for at least one week, two weeks, three weeks or four weeks, most preferably, for at least 1 month, 2 months, 3 months or 4 months, wherein “retains” indicates that the reduction in hardness is less than 5%, 4%, 3%, preferably less than 2% or 1%. In particular, a crisp baked product according to the invention having an a_{w} of at least 0.35 retains its hardness for at least 1, 2 or 3 years. The crisp baked product according to the invention can be baked to achieve an a_{w} of at least 0.35 or, alternatively, can be baked to an a_{w} of less than 0.35 and a moisture content of lower than 5% w/w and equilibrate to an a_{w} of at least 0.35 and a moisture content of at least 5% w/w by post-baking events, such as exposure to the atmosphere or contact with composite parts, such as fillings and coatings, when these bring additional sources of moisture.

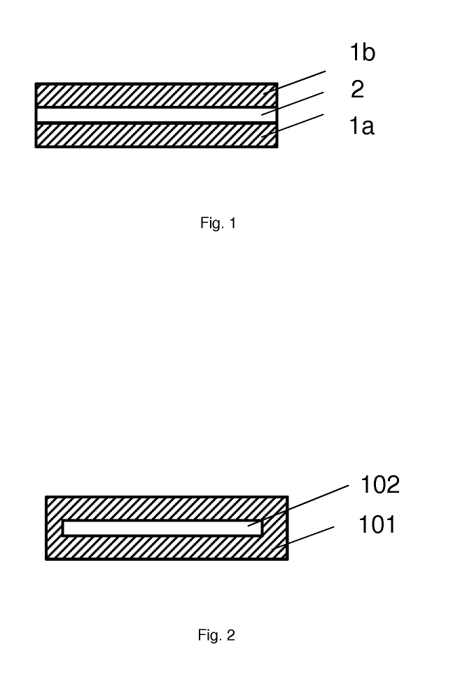

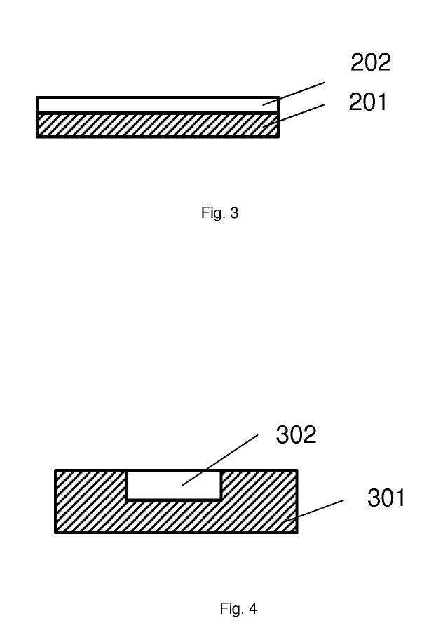

A preferred embodiment of the invention are sandwich biscuits made from the short-dough process, which by using a sufficient amount of xylanase to improve the hard/crisp/crunchy textural quality at relatively high a_{w} and moisture levels, extends the formulation scope of the filling and permits the creation of novel composite-biscuits of more contrasting texture, for example as schematically depicted in FIG. 1-4.

The embodiments mentioned for the methods are also applicable to the products prepared by the method, and vice versa. The skilled person will understand that what has been described for biscuits is also applicable to other crisp baked products.

It is noted that U.S. Pat. No. 5,176,927 describes a method of improving the production process of dry cereal products by enzyme addition.

It is noted that EP1982598 describes moisture resistant wafers.

It is noted that XP-002690056 & JP 8084557 describe a method for producing a baked good, adding a xylanase to dough containing wheat flour, moulding and baking such dough.

It is noted that EP1415539 describes a flour based food product comprising thermostable alpha-amylase.

### EXAMPLES

### Example 1

Digestive biscuits were made using the basic recipe in Table 1. This recipe forms a “short-dough” formulation that was mixed in a Hobart mixer. The dough was shaped by rotary-moulder and then baked in a Spooner travelling oven at 245° C. for 6.5 minutes. The biscuits were of oval shape: approximately 6.7 cm in length, 4.1 cm in width and 0.97 cm in depth, using a biscuit mould to give a ribbed surface with the ribs around 3.5 mm in depth. A “control” recipe was prepared precisely following the recipe of Table 1, while a recipe according to the invention additionally included Bakezyme Real-X (DSM Food Specialties, Netherlands) at 80 ppm, providing an activity of 1760 xylanase units/kg of flour within the dough.

TABLE 1
Basic recipe for digestive biscuit

| | Amount (wt % based |
|---|---|
| Ingredient | on flour weight) |
| White flour (biscuit, Golden Dawn) | 78 |
| Wholemeal flour | 22 |
| Fat (frying) | 32.15 |
| Caster sugar | 15 |
| Demerara sugar | 15 |
| Water | 12.5 |
| Simmed milk powder | 1.75 |
| Salt | 1.05 |
| Sodium bicarbonate | 0.35 |
| Ammonium bicarbonate | 0.20 |

The properties of biscuits after baking were as shown in Table 2. Mass, stack height, moisture and water activity were determined by standard laboratory methodology. For water activity an Aqua Lab 4TE (Decagon Devices, UK) was used. For hardness, a 3-point bend test was followed using an SMS TAXT2 plus (Stable Micro Systems, UK). The biscuit was suspended across two mounts, 2 cm apart, before a rounded probe 6 mm in width (supplied by Stable Micro Systems UK) was depressed into the biscuit at a point midway between the two mounts. The maximum force recorded before the biscuit fractured is defined as the value for “hardness”. Test conditions were as follows: pre-test 1 mm/s, trigger force 5 g, test-speed 3 mm/s.

It will be seen from Table 2 that there was close similarity between the control and biscuit according to the invention.

TABLE 2
Properties of “control” and digestive biscuit according to the invention
following equivalent methods of dough preparation and baking

| | |
|---|---|
| Digestive biscuit | Digestive with |
| with no added | added xylanase |
| xylanase | 1760 xylanase |
| (control) | units/kg of flour |

| | | | | |
|---|---|---|---|---|
| Mass 10 biscuits | 124.4 | g | 127.8 | g |
| Stack height 10 biscuits | 98 | mm | 96 | mm |
| Moisture | 4.28 | wt % | 4.04 | wt % |

| | | |
|---|---|---|
| Water activity | 0.266 | 0.243 |

| | | | | |
|---|---|---|---|---|
| Hardness | 4.37 | kg | 4.36 | kg |

The biscuits were then re-equilibrated to a water activity of 0.45 by placing these in cabinets where the ERH was carefully controlled to 45% of relative humidity at atmospheric pressure and at 20 degrees ° C. The characteristics of the biscuits were monitored over time until these had fully equilibrated and there was no further change with respect to moisture absorption or hardness of the biscuit. The characteristics of the biscuits are shown in Table 3.

It will be seen that both control and biscuit according to the invention absorbed essentially the same amount of moisture as these equilibrated to a water activity of 0.45. With respect to the hardness values given in Table 2, the biscuit according to the invention lost only 15% whilst the control lost 30% of their initial hardness. This then provides evidence for the advantageous use of xylanase to allow biscuits to be of higher moisture and higher water activity whilst retaining improved hardness relative to products made without added xylanase.

TABLE 3
Properties of “control” and digestive biscuit according to the
invention following re-equlibration to water activity of 0.45

| | |
|---|---|
| Digestive biscuit | Digestive with |
| with no added | added xylanase |
| xylanase | (1760 xylanase |
| (control) | units/kg of flour) |

| | | | | |
|---|---|---|---|---|
| Moisture | 6.15 | wt % | 6.11 | wt % |

| | | |
|---|---|---|
| Water activity | 0.45 | 0.45 |

| | | | | |
|---|---|---|---|---|
| Hardness | 3.04 | kg | 3.71 | kg |

### Example 2

The influence of the xylanase on Farinogram® graphs is shown in Table 4. The Farinogram® graphs were obtained using a Farinograph (Brabender Technologie KG, Germany) and used 300 g biscuit flour (of 14% moisture equivalence based on the weight of the flour) and water sufficient to achieve a dough consistency to the 600 Brabender Units (BU) line (49.1% water on flour weight), with the bowl incubated to 30° C. The dough was mixed to peak torque and then degree-of-softening was measured by recording the decrease in BU over the next 12 minutes. Separately measures for “development time” and “dough stability” were also recorded, these being defined as follows: (i) development time=the time to reach peak torque and (ii) dough stability=time interval on Farinograph time from when the dough first rises higher than the 600BU to when its dips lower than this line.

It will be seen that xylanase leads to a rapid increase in the fluidity of the dough by the measure “degree-of-softening”, giving values substantially in excess of the control. Where a “degree-of-softening” of at least 50 BU was obtained, these concentrations of enzyme can be used to make crisp baked products according to the invention. These results show that this measure can be used to select xylanase types and xylanase amounts that can improve hardness in biscuits of high a_{w} or moisture.

TABLE 4
Influence of xylanase on Farinograms

| | | | | Degree-of- |
|---|---|---|---|---|
| Xylanase | Dough | Dough | Degree-of- | softening (BU) |
| (Xylanase | Development | stability | softening | in excess |
| units) | (min) | (min) | (BU) | of control |
| 0 | 1.4 | 2.8 | 138 | 0 (by definition) |
| 440 | 2 | 2.5 | 180 | 42 |
| 880 | 1.5 | 1.5 | 190 | 52 |
| 1760 | 1.5 | 1.5 | 218 | 80 |
| 3520 | 1.5 | 1.5 | 250 | 112 |

1. A method for preparing a crisp baked product comprising:
preparing a wheat flour dough or batter with added xylanase;
baking the dough to make a crisp baked product
which on production or after storage has a water activity (a_{w}) of at least 0.35 while having at least 80% of the hardness of a reference crisp baked product prepared with no added xylanase with a water activity (a_{w}) of about 0.25, wherein the xylanase is an endo-1,4-beta-xylanase (EC 3.2.1.8).

2. A method according to claim 1, wherein the xylanase used in the dough or batter is of a type and in sufficient amounts to cause a degree of softening in a Farinograph® machine which is at least 50 Brabender Units with respect to a reference dough or batter to which no xylanase has been added.

3. A method according to claim 1, wherein the wheat flour dough or batter comprises 880-8000 xylanase units/kg of flour.

4. A method according to claim 1, wherein the xylanase is obtainable from a bacterium, a yeast, a fungus or a plant cell.

5. A method according to claim 4, wherein the fungus is a filamentous fungus, optionally belonging to Aspergillus, Humicola, Talaromyces or Trichoderma.

6. A method according to claim 1, wherein the biscuit produced is a cracker, a semi-sweet biscuit, a crispbread, a digestive, cookie, a shortbread, a wafer, a sandwich biscuit, a composite biscuit or a filled biscuit.

7. A crisp baked product with a moisture level of 5% w/w or more prepared by the method according to claim 1 which has improved hardness compared to a reference crisp baked product with similar moisture level.

8. A crisp baked product prepared from a wheat flour dough or batter with added xylanase which on production or after storage has a water activity (a_{w}) of at least 0.35 while having at least 80% of the hardness of a reference crisp baked product prepared with no added xylanase with a water activity (a_{w}) of about 0.25, wherein the xylanase is an endo-1,4-beta-xylanase (EC 3.2.1.8).

9. A crisp baked product according to claim 8, wherein the product retains hardness for at least 3 days at an a_{w} of at least 0.35 once equilibrated with an environment.

10. A crisp baked product according to claim 7, wherein the product is a biscuit product, optionally a hard-dough biscuit product, a short-dough biscuit product or a wafer biscuit product.

11. A crisp baked product according to claim 7, wherein the biscuit product is a cracker, a semi-sweet biscuit, a crispbread, a digestive, cookie, a shortbread, a wafer, a composite biscuit.

12. A crisp baked product according to claim 11, wherein the composite biscuit comprises a jam filling, a cream filling or jelly inclusions.

13. A xylanase in a dough or batter capable of being used to prepare a crisp baked product according to claim 7.

14. A Farinograph® machine capable of being used to select a type and amount of xylanase to produce a crisp baked product according to claim 7.
